(19) United States
(12) Patent Application Publication
(10) Pub. No.: US 2014/0138223 A1
(43) Pub. Date: May 22, 2014

(54) SCISSORS-TYPE CONNECTING MEMBER AND KEY STRUCTURE WITH SCISSORS-TYPE CONNECTING MEMBER

(71) Applicant: PRIMAX ELECTRONICS LTD., Taipei (TW)

(72) Inventors: Chuang-Shu Jhuang, Taipei (TW); Hui Ma, Taipei (TW)

(73) Assignee: PRIMAX ELECTRONICS LTD., Taipei (TW)

(21) Appl. No.: 13/737,633

(22) Filed: Jan. 9, 2013

(30) Foreign Application Priority Data
Nov. 22, 2012 (CN) 201210478428.8

(51) Int. Cl. H01H 13/14

(52) U.S. Cl. CPC H01H 13/14
USPC 200/344

(57) ABSTRACT

A key structure with a scissors-type connecting member is provided. The key structure includes a base plate, a scissors-type connecting member, and a keycap. The scissors-type connecting member includes a first frame and a second frame. The first frame includes a rotating shaft and an extension bulge. The second frame includes a receiving recess and a position-limiting cavity. For combining the first frame with the second frame, the rotating shaft is inserted into the receiving recess and the extension bulge is inserted into the position-limiting cavity. Consequently, a rotating range of the extension bulge is limited.

### FIELD OF THE INVENTION

The present invention relates to an input device, and more particularly to a key structure of a scissors-type connecting member.

### BACKGROUND OF THE INVENTION

Generally, the widely-used peripheral input device of a computer includes for example a mouse device, a keyboard device, a trackball device, or the like. Via the keyboard device, the user may directly input characters and symbols into the computer. As a consequence, most users and most manufacturers of the input devices pay much attention to the keyboard devices.

Hereinafter, the configurations and the functions of a conventional keyboard device will be illustrated with reference to FIG. 1. FIG. 1 is a schematic top view illustrating the outward appearance of a conventional keyboard device. As shown in FIG. 1, plural keys 10 are installed on a surface of the conventional keyboard device 1. These keys 10 are classified into some types, e.g. ordinary keys, numeric keys and function keys. When one or more keys 10 are depressed by the user's fingers, a corresponding electronic signal is issued to the computer, and thus the computer executes a function corresponding to the depressed key or keys. For example, when an ordinary key is depressed, a corresponding English letter or symbol is inputted into the computer. When a numeric key is depressed, a corresponding number is inputted into the computer. In addition, the function keys (F1˜F12) can be programmed to cause corresponding application programs to provide certain functions.

Hereinafter, the components of a key structure of the conventional keyboard device will be illustrated with reference to FIG. 2. FIG. 2 is a schematic exploded view illustrating a key structure of a conventional keyboard device. As shown in FIG. 2, the key structure 2 comprises a keycap 21, a scissors-type connecting member 22, an elastic element 23, a membrane switch circuit 24, and a base plate 25. The keycap 21 may be touched and depressed by the user. In addition, the keycap 21 is connected with the scissors-type connecting member 22. The scissors-type connecting member 22 is arranged between the keycap 21 and the base plate 25. In addition, the scissors-type connecting member 22 is connected with the keycap 21 and the base plate 25. The scissors-type connecting member 22 comprises an inner frame 221 and an outer frame 222. The inner frame 221 has a rotating shaft 2211. The outer frame 222 has two openings 2221 corresponding to the rotating shaft 2211. After the rotating shaft 2211 is penetrated through the openings 2221, the inner frame 221 and the outer frame 222 are connected with each other, and the inner frame 221 is swingable relative to the outer frame 222. The membrane switch circuit 24 is disposed on the base plate 25. The elastic element 23 is arranged between the keycap 21 and the membrane switch circuit 24. When the keycap 21 is depressed, the elastic element 23 is deformed downwardly to trigger the membrane switch circuit 24, so that the membrane switch circuit 24 generates a corresponding electronic signal.

In a case that the key structure 2 is not depressed, the keycap 21 of the key structure 2 is located at a first height (not shown). Whereas, when the key structure 2 is depressed, a downward pressing force is exerted on the keycap 21, and the elastic element 23 is compressed in response to the pressing force. Moreover, as the keycap 21 is depressed, the inner frame 221 and the outer frame 222 of the scissors-type connecting member 22 are correspondingly swung with the keycap 21. Consequently, the inner frame 221 and the outer frame 222 are parallel with each other. At the same time, the membrane switch circuit 24 on the base plate 25 is pressed and triggered by the elastic element 23. Consequently, the membrane switch circuit 24 generates a corresponding electronic signal. Meanwhile, the keycap 21 of the key structure 2 is descended from the first height to a second height (not shown). The difference between the first height and the second height indicates a travelling distance of the key structure 2.

In a case that the pressing force exerted on the keycap 21 is eliminated, the keycap 21 will be moved upwardly in response to a restoring force of the elastic element 23. As the keycap 21 is moved upwardly, the inner frame 221 and the outer frame 222 are towed by the keycap 21 and correspondingly rotated. Consequently, the keycap 21 is returned to its original position where the keycap 21 has not been depressed (i.e. at the first height).

From the above discussions, after the pressing force exerted on the keycap 21 is eliminated, the keycap 21 should be moved upwardly and returned to its original position (i.e. at the first height). For achieving this purpose, the elastic element 23 should provide a sufficient restoring force to push the keycap 21 back to its original position. In addition, the inner frame 221 and the outer frame 222 need to cooperate with each other to precisely control the upward moving action of the keycap 21 in the vertical direction. In other words, the performance of the scissors-type connecting member 22 is a very important factor that influences the quality and the use life of the key structure 2. Moreover, for combining the inner frame 221 with the outer frame 222, the user needs to prop open the outer frame 222 to widen the distance between the two openings 2221, which are respectively located at bilateral sides of the outer frame 222. Consequently, the rotating shaft 2211 can be successfully inserted into the openings 2221 to result in the combination between the inner frame 221 and the outer frame 222. The procedure of propping-open the outer frame 222 increases the assembling time of the key structure 2 and is detrimental to the throughput of the keyboard device. Moreover, since the outer frame 222 has the openings 2221, if the thickness of the key structure 2 is slimed, the whole structure of the outer frame 222 becomes weak and is easily damaged. In other words, the conventional scissors-type connecting member 22 is not suitable for slimness of the key structure 2.

### SUMMARY OF THE INVENTION

The present invention provides an easily-assembled scissors-type connecting member and a key structure with such a scissors-type connecting member.

The present invention also provides a low-damage scissors-type connecting member and a key structure with such a scissors-type connecting member.

In accordance with an aspect of the present invention, there is provided a scissors-type connecting member. The scissors-type connecting member includes a first frame and a second frame. The first frame includes a rotating shaft. The rotating shaft is disposed on a first sidewall of the first frame. The rotating shaft has an extension bulge. The extension bulge is disposed on an axial surface of the rotating shaft. The second frame is connected with the first frame and swingable relative to the first frame, and includes a receiving recess. The receiving recess is formed in a second sidewall of the second frame for accommodating the rotating shaft. A position-limiting cavity is disposed within the receiving recess for accommodating the extension bulge, thereby limiting a rotating range of the extension bulge.

In an embodiment, the second frame further includes a sliding recess. The sliding recess is formed in the second sidewall of the second frame and in communication with the receiving recess. As the rotating shaft is contacted with the sliding recess, the rotating shaft is inserted into the sliding recess and further moved on the second sidewall of the second frame along the sliding recess, so that the rotating shaft is introduced into the receiving recess and accommodated within the receiving recess.

In an embodiment, the second frame further includes a guiding slant. The guiding slant is formed in a top surface of the second frame and in communication with the sliding recess for guiding the rotating shaft to be introduced into the sliding recess. As the rotating shaft is contacted with the top surface of the second frame, the rotating shaft is contacted with the guiding slant and further moved into the sliding recess along the guiding slant.

In an embodiment, the first frame further includes an auxiliary slant. The auxiliary slant is formed on the axial surface of the rotating shaft, and disposed under the extension bulge to be contacted with the guiding slant, thereby assisting in introducing the rotating shaft into the sliding recess. As the rotating shaft is contacted with the top surface of the second frame, the auxiliary slant is contacted with the guiding slant and moved along the guiding slant, so that the rotating shaft is introduced into the sliding recess.

In an embodiment, a profile of the position-limiting cavity is identical to a profile of the extension bulge, and a size of the position-limiting cavity is larger than a size of the extension bulge.

In an embodiment, the first frame is an inner frame, and the second frame is an outer frame. The first frame is coupled to an inner side of the second frame.

In accordance with another aspect of the present invention, there is provided a key structure. The key structure includes a base plate, a keycap, and a scissors-type connecting member. The keycap is disposed over the base plate. The scissors-type connecting member is arranged between the base plate and the keycap for connecting the base plate with the keycap, so that the keycap is movable upwardly or downwardly relative to the base plate. The scissors-type connecting member includes a first frame and a second frame. The first frame includes a rotating shaft. The rotating shaft is disposed on a first sidewall of the first frame. The rotating shaft has an extension bulge. The extension bulge is disposed on an axial surface of the rotating shaft. The second frame is connected with the first frame and swingable relative to the first frame, and includes a receiving recess. The receiving recess is formed in a second sidewall of the second frame for accommodating the rotating shaft. A position-limiting cavity is disposed within the receiving recess for accommodating the extension bulge, thereby limiting a rotating range of the extension bulge.

In an embodiment, the second frame further includes a sliding recess. The sliding recess is formed in the second sidewall of the second frame and in communication with the receiving recess. As the rotating shaft is contacted with the sliding recess, the rotating shaft is inserted into the sliding recess and further moved on the second sidewall of the second frame along the sliding recess, so that the rotating shaft is introduced into the receiving recess and accommodated within the receiving recess.

In an embodiment, the second frame further includes a guiding slant. The guiding slant is formed on a top surface of the second frame and in communication with the sliding recess for guiding the rotating shaft to be introduced into the sliding recess. As the rotating shaft is contacted with the top surface of the second frame, the rotating shaft is contacted with the guiding slant and further moved into the sliding recess along the guiding slant.

In an embodiment, the first frame further includes an auxiliary slant. The auxiliary slant is formed on the axial surface of the rotating shaft, and disposed under the extension bulge to be contacted with the guiding slant, thereby assisting in introducing the rotating shaft into the sliding recess. As the rotating shaft is contacted with the top surface of the second frame, the auxiliary slant is contacted with the guiding slant and moved along the guiding slant, so that the rotating shaft is introduced into the sliding recess.

In an embodiment, a profile of the position-limiting cavity is identical to a profile of the extension bulge, and a size of the position-limiting cavity is larger than a size of the extension bulge.

In an embodiment, the key structure further includes a membrane switch circuit and an elastic element. The membrane switch circuit is disposed on the base plate. When the membrane switch circuit is triggered, the membrane switch circuit generates a key signal. The elastic element is disposed on the membrane switch circuit. A lower portion of the elastic element is contacted with the membrane switch circuit. The elastic element is penetrated through the scissors-type connecting member. An upper portion of the elastic element is contacted with the keycap. When the elastic element is pushed by the keycap, the membrane switch circuit is triggered by the elastic element. When a pressing force exerted on the keycap is eliminated, an elastic force provided by the elastic element is exerted on the keycap.

In an embodiment, the first frame is an inner frame, and the second frame is an outer frame. The first frame is coupled to an inner side of the second frame.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic top view illustrating the outward appearance of a conventional keyboard device;

FIG. 2 is a schematic exploded view illustrating a key structure of a conventional keyboard device;

FIG. 3 is a schematic exploded view illustrating a key structure with a scissors-type connecting member according to a first embodiment of the present invention;

FIG. 4 is a schematic exploded view illustrating a first frame and a second frame of the scissors-type connecting member of the key structure according to the first embodiment of the present invention;

FIGS. 5A, 5B and 5C are schematic side views illustrating a process of assembling the scissors-type connecting member of the key structure according to the first embodiment of the present invention;

FIG. 6 is a schematic assembled view illustrating the scissors-type connecting member of the key structure according to the first embodiment of the present invention, in which the scissors-type connecting member is in an open-scissors state;

FIG. 7 is a schematic partial side view illustrating the second frame of the scissors-type connecting member of the key structure according to the first embodiment of the present invention; and

FIG. 8 is a schematic partial side view illustrating a second frame of a scissors-type connecting member of a key structure according to a second embodiment of the present invention.

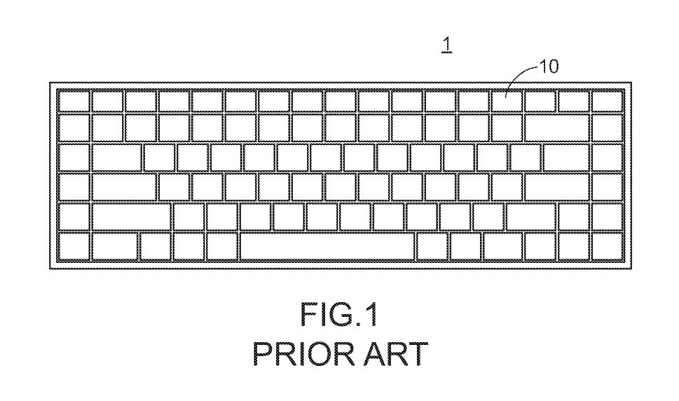

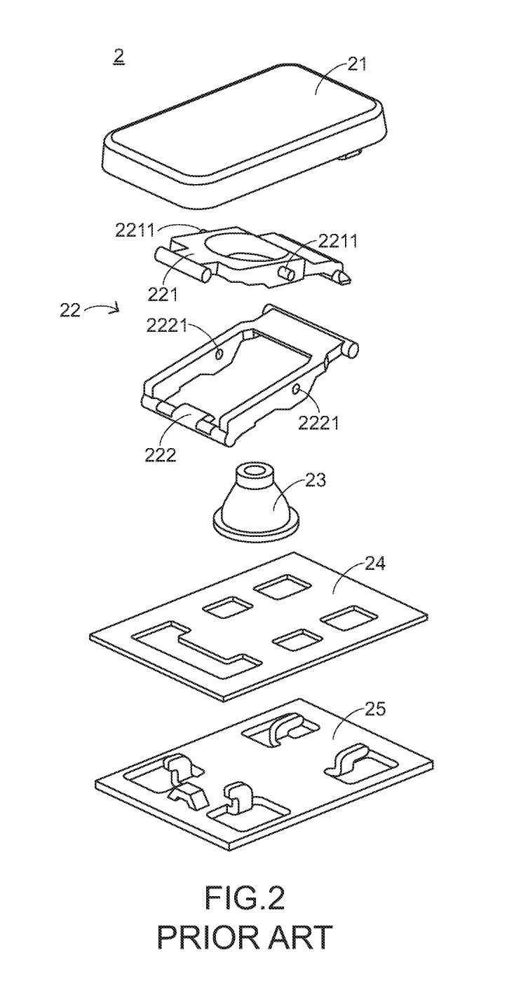

### DETAILED DESCRIPTION OF THE PREFERRED EMBODIMENT

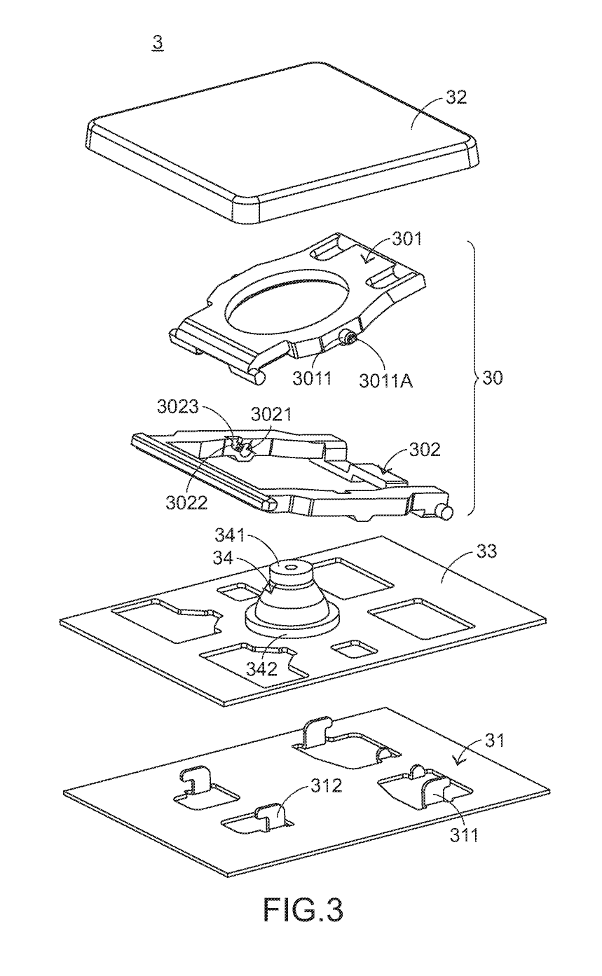

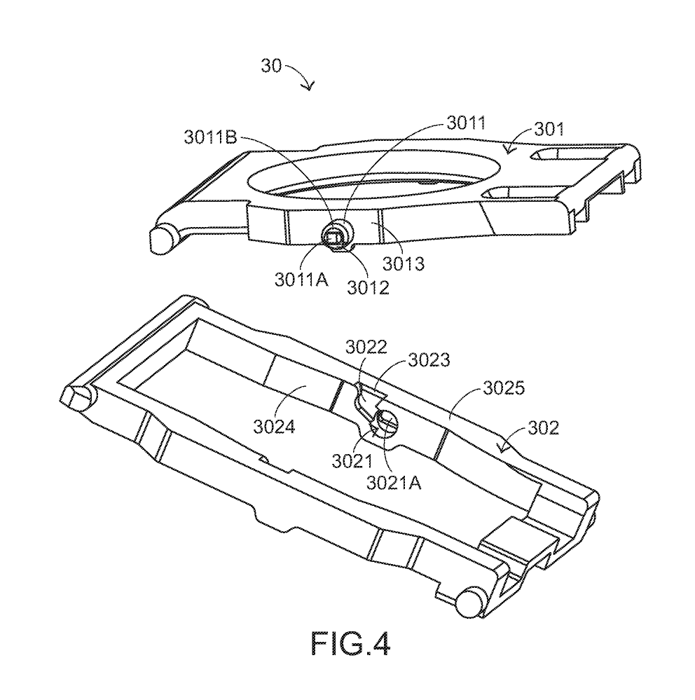

For obviating the drawbacks encountered from the prior art, the present invention provides a scissors-type connecting member and a key structure with such a scissors-type connecting member. Hereinafter, a key structure and a scissors-type connecting member thereof will be illustrated with reference to FIGS. 3 and 4. FIG. 3 is a schematic exploded view illustrating a key structure with a scissors-type connecting member according to a first embodiment of the present invention. FIG. 4 is a schematic exploded view illustrating a first frame and a second frame of the scissors-type connecting member of the key structure according to the first embodiment of the present invention. As shown in FIGS. 3 and 4, the key structure 3 comprises a scissors-type connecting member 30, a base plate 31, a keycap 32, a membrane switch circuit 33, and an elastic element 34. The scissors-type connecting member 30 is arranged between the keycap 32 and the membrane switch circuit 33. The scissors-type connecting member 30 comprises a first frame 301 and a second frame 302. The first frame 301 and the second frame 302 are connected with each other. In addition, the second frame 302 is swingable relative to the first frame 301. In this embodiment, the first frame 301 is an inner frame, and the second frame 302 is an outer frame. Moreover, the first frame 301 is coupled to an inner side of the second frame 302.

Please refer to FIG. 3 again. The membrane switch circuit 33 is arranged between the base plate 31 and the elastic element 34. When the membrane switch circuit 33 is triggered, the membrane switch circuit 33 issues a key signal. The elastic element 34 is arranged between the keycap 32 and the membrane switch circuit 33. In addition, the elastic element 34 comprises an upper portion 341 and a lower portion 342. For combining the components of the key structure 3 together, the elastic element 34 is penetrated through a central hollow portion (not shown) of the first frame 301, the upper portion 341 of the elastic element 34 is contacted with the keycap 32, and the lower portion 342 of the elastic element 34 is contacted with the membrane switch circuit 33. The base plate 31 is disposed under the membrane switch 33. In addition, the base plate 31 comprises a first hook 311 and a second hook 312. The first hook 311 is located at a first side of the base plate 31 to be connected with a first end of the second frame 302. The second hook 312 is located at a second side of the base plate 31 to be connected with a second end of the first frame 301. Similarly, for connecting the keycap 32 with the scissors-type connecting member 30, the keycap 32 further comprises hooking structures (not shown) similar to the first hook 311 and the second hook 312 of the base plate 31. Via these hooking structures, a first end of the first frame 301 and a second end of the second frame 302 can be connected with the keycap 32.

The detailed configurations of the scissors-type connecting member 30 will be illustrated as follows. The first frame 301 of the scissors-type connecting member 30 comprises a rotating shaft 3011 and an auxiliary slant 3012. The second frame 302 of the scissors-type connecting member 30 comprises a receiving recess 3021, a sliding recess 3022, and a guiding slant 3023. In the first frame 301, the rotating shaft 3011 is disposed on a first sidewall 3013 of the first frame 301. Moreover, the rotating shaft 3011 has an extension bulge 3011A, which is disposed on an axial surface 3011B of the rotating shaft 3011. The auxiliary slant 3012 is formed on the axial surface 3011B of the rotating shaft 3011, and disposed under the extension bulge 3011A. The auxiliary slant 3012 may be contacted with the guiding slant 3023 in order to assist in introducing the rotating shaft 3011 into the sliding recess 3022. For example, as the rotating shaft 3011 is contacted with a top surface 3025 of the second frame 302, the auxiliary slant 3012 may be contacted with the guiding slant 3023 and further moved along the guiding slant 3023. Consequently, the rotating shaft 3011 may be smoothly introduced into the sliding recess 3022. In this embodiment, the rotating shaft 3011, the auxiliary slant 3012 and the extension bulge 3011A are integrally formed with the first frame 301.

In the second frame 302, the receiving recess 3021 is formed in a second sidewall 3024 of the second frame 302. The receiving recess 3021 is used for accommodating the rotating shaft 3011. Moreover, a position-limiting cavity 3021A is disposed within the receiving recess 3021 for accommodating the extension bulge 3011A, thereby limiting a rotating range of the extension bulge 3011A. That is, due to the structures of the extension bulge 3011A and the position-limiting cavity 3021A, the swinging range of the second frame 302 relative to the first frame 301 is limited. Moreover, the sliding recess 3022 is formed in the second sidewall 3024 of the second frame 302 and in communication with the receiving recess 3021. As the rotating shaft 3011 is contacted with the sliding recess 3022, the rotating shaft 3011 may be inserted into the sliding recess 3022 and further moved on the second sidewall 3024 of the second frame 302 along the sliding recess 3022. Consequently, the rotating shaft 3011 will be introduced into the receiving recess 3021 and accommodated within the receiving recess 3021. The guiding slant 3023 is formed on the top surface 3025 of the second frame 302 and in communication with the sliding recess 3022. The guiding slant 3023 is used for guiding the rotating shaft 3011 to be introduced into the sliding recess 3022. As the rotating shaft 3011 is contacted with the top surface 3025 of the second frame 302, the rotating shaft 3011 may be contacted with the guiding slant 3023 and further moved into the sliding recess 3022 along the guiding slant 3023.

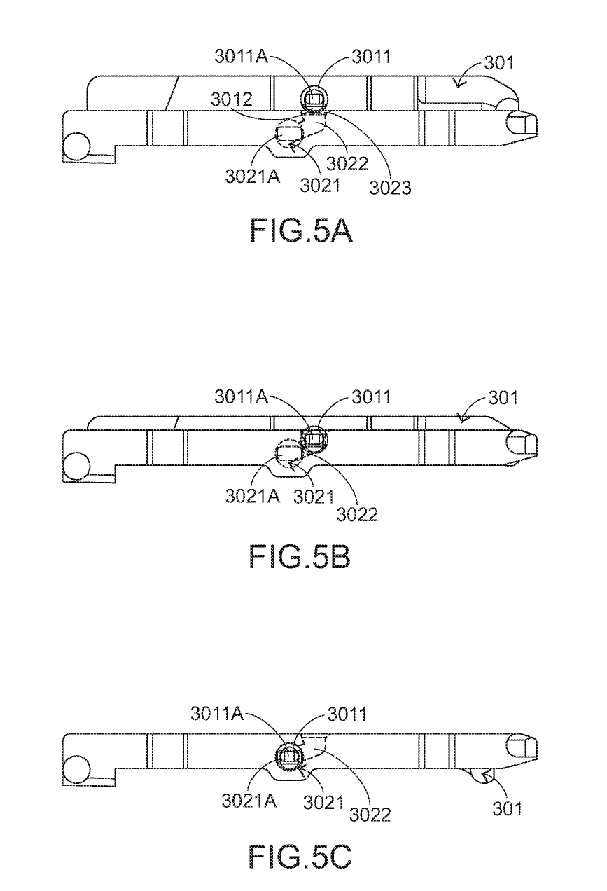

Hereinafter, a process of combining the first frame 301 with the second frame 302 will be illustrated with reference to FIGS. 4, 5A, 5B and 5C. FIGS. 5A, 5B and 5C are schematic side views illustrating a process of assembling the scissors-type connecting member of the key structure according to the first embodiment of the present invention. The process of assembling the scissors-type connecting member 30 by combining the first frame 301 with the second frame 302 comprises the following steps. Firstly, the first frame 301 is firstly stacked on the second frame 302, and the rotating shaft 3011 of the first frame 301 is aligned with the guiding slant 3023 of the second frame 302. Consequently, the auxiliary slant 3012 on the axial surface 3011B of the rotating shaft 3011 is contacted with the guiding slant 3023 (see FIG. 5A). Then, a downward pressing force is exerted on the first frame 301. In response to the pressing force, the first frame 301 is moved downwardly. Meanwhile, due to the structures of the auxiliary slant 3012 and the guiding slant 3023, the rotating shaft 3011 is introduced into the sliding recess 3022 (see FIG. 5B). As the downward pressing force is continuously exerted on the first frame 301, the rotating shaft 3011 of the first frame 301 is moved toward the receiving recess 3021 along the sliding recess 3022. Afterwards, the rotating shaft 3011 is moved on the second sidewall 3024 of the second frame 302. Consequently, the rotating shaft 3011 is introduced into the receiving recess 3021 and accommodated within the receiving recess 3021, and the extension bulge 3011A is accommodated within the position-limiting cavity 3021A (see FIG. 5C).

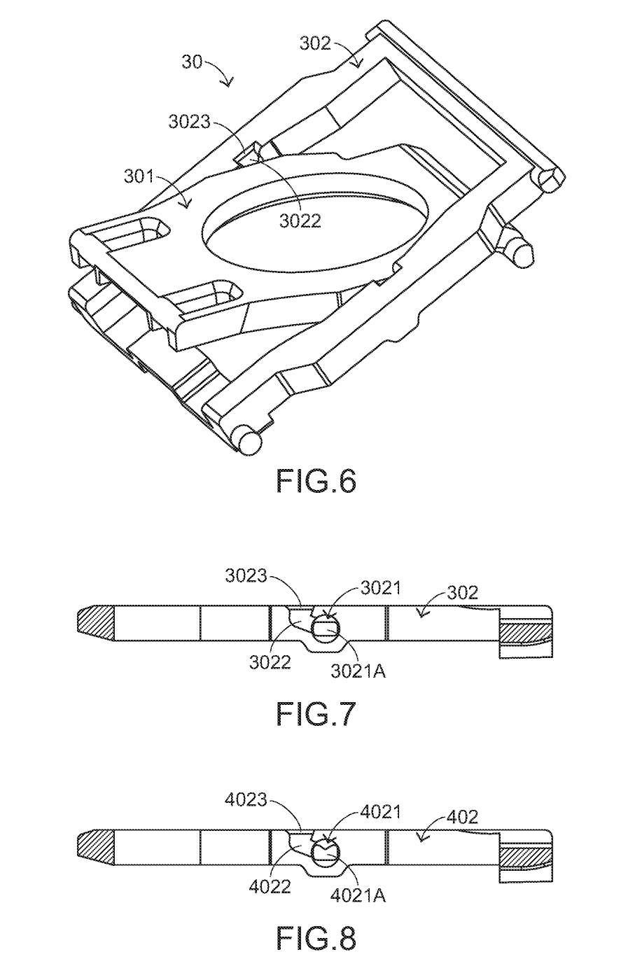

FIG. 6 is a schematic assembled view illustrating the scissors-type connecting member of the key structure according to the first embodiment of the present invention, in which the scissors-type connecting member is in an open-scissors state. The combination of the first frame 301 and the second frame 302 is shown in FIG. 6. Due to the structures of the extension bulge 3011A and the position-limiting cavity 3021A, the swinging range of the second frame 302 relative to the first frame 301 is limited. As shown in FIG. 6, the second frame 302 is swung relative to the first frame 301 until the extension bulge 3011A is limited by the position-limiting cavity 3021A. Under this circumstance, the scissors-type connecting member 30 is in an open-scissors state. In a case that the scissors-type connecting member 30 is in the open-scissors state, if the user wants to release the open-scissors state, an enough external force is needed. In other words, during the process of assembling the key structure 3, the scissors-type connecting member 30 can be maintained in the open-scissors state, and thus the scissors-type connecting member 30 can be easily combined with the base plate 31 and the keycap 32.

Please refer to FIG. 3 again. As the keycap 32 of the key structure 3 with the scissors-type connecting member 30 is depressed, the second frame 302 of the scissors-type connecting member 30 is swung relative to the first frame 301. Since the rotating range of the extension bulge 3011A within the position-limiting cavity 3021A is limited, the scissors-type connecting member 30 is switched from the open-scissors state to a folded state. Moreover, in response to the pressing force, the keycap 32 is moved downwardly to push against the elastic element 34, and thus the membrane switch circuit 33 is triggered by the elastic element 34 to generate a key signal. Whereas, when the pressing force exerted on the keycap 32 is eliminated, an elastic force provided by the elastic element 34 is acted on the keycap 32. Due to the elastic force, the second frame 302 is swung relative to the first frame 301, and the keycap 32 is returned to its original location where the keycap 32 has not been depressed. The operations of the key structure 3 with the scissors-type connecting member 30 have been described above.

FIG. 7 is a schematic partial side view illustrating the second frame of the scissors-type connecting member of the key structure according to the first embodiment of the present invention. As shown in FIG. 7, the position-limiting cavity 3021A has a rectangular profile. As shown in FIG. 4, the extension bulge 3011A also has the rectangular profile. That is, the profile of the position-limiting cavity 3021A is identical to the profile of the extension bulge 3011A. In addition, the size of the position-limiting cavity 3021A is larger than the size of the extension bulge 3011A. Consequently, the extension bulge 3011A is rotatable within the position-limiting cavity 3021A in a limited rotating range while the scissors-type connecting member 30 is maintained in the open-scissors state. In other words, the structures of the scissors-type connecting member 30 can facilitate the assemblage of the key structure 3.

The present invention further provides a second embodiment of a key structure with a scissors-type connecting member. The base plate, the keycap, the membrane switch circuit and the elastic element included in the key structure of the second embodiment are similar to those of the first embodiment, and are not redundantly described herein. Hereinafter, the scissors-type connecting member of the key structure according to the second embodiment of the present invention will be illustrated with reference to FIG. 8. FIG. 8 is a schematic partial side view illustrating a second frame of a scissors-type connecting member of a key structure according to a second embodiment of the present invention. For clarification and brevity, only a second frame 402 of the scissors-type connecting member is shown in FIG. 8. The second frame 402 comprises a receiving recess 4021, a sliding recess 4022, and a guiding slant 4023. Except that the profile of the position-limiting cavity 4021A within the receiving recess 4021 is not rectangular, the structures of the other components of the second frame 402 are similar to those of the first embodiment, and are not redundantly described herein. In this embodiment, the two top corners of the position-limiting cavity 4021A are extended upwardly, so that the position-limiting cavity 4021A has a notched semi-circular profile. Due to this special profile of the position-limiting cavity 4021A, the rotating range of the extension bulge within the position-limiting cavity 4021A is larger than the rotating range of the first embodiment. Of course, in a case that the extension bulge is rotated within the position-limiting cavity 4021A in the limited rotating range, the scissors-type connecting member can be still maintained in the open-scissors state. Consequently, the structures of the scissors-type connecting member can facilitate the assemblage of the key structure. In other words, the profile of the position-limiting cavity may be varied according to the practical requirements.

From the above descriptions, the present invention provides a scissors-type connecting member and a key structure with such a scissors-type connecting member. The scissors-type connecting member comprises a first frame and a second frame. A receiving recess is formed in the second frame to replace the opening of the conventional scissors-type connecting member. Consequently, the structural strength of the second frame is enhanced, and the possibility of causing damage of the second frame is largely reduced. Moreover, since an extension bulge is disposed on a rotating shaft of the first frame and a position-limiting cavity is disposed within the receiving recess of the second frame, the rotating range of the extension bulge is limited by the position-limiting cavity. Since the rotating range of the extension bulge is limited by the position-limiting cavity, the scissors-type connecting member can be maintained in the open-scissors state. Consequently, the structures of the scissors-type connecting member can facilitate the assemblage of the key structure. Moreover, an auxiliary slant is formed on the rotating shaft of the first frame and disposed under the extension bulge, but no auxiliary slant is disposed over the extension bulge. During the process of combining the first frame with the second frame, the auxiliary slant may be considered as a foolproof structure for preventing the first frame to be stacked on the second frame in a wrong direction. Consequently, the possibility of erroneously combining the first frame with the second frame will be eliminated.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A scissors-type connecting member, comprising:
a first frame comprising a rotating shaft, wherein said rotating shaft is disposed on a first sidewall of said first frame, wherein said rotating shaft has an extension bulge, and said extension bulge is disposed on an axial surface of said rotating shaft; and
a second frame connected with said first frame and swingable relative to said first frame, and comprising a receiving recess, wherein said receiving recess is formed in a second sidewall of said second frame for accommodating said rotating shaft, wherein a position-limiting cavity is disposed within said receiving recess for accommodating said extension bulge, thereby limiting a rotating range of said extension bulge.

2. The scissors-type connecting member according to claim 1, wherein said second frame further comprises a sliding recess, wherein said sliding recess is formed in said second sidewall of said second frame and in communication with said receiving recess, wherein as said rotating shaft is contacted with said sliding recess, said rotating shaft is inserted into said sliding recess and further moved on said second sidewall of said second frame along said sliding recess, so that said rotating shaft is introduced into said receiving recess and accommodated within said receiving recess.

3. The scissors-type connecting member according to claim 2, wherein said second frame further comprises a guiding slant, wherein said guiding slant is formed on a top surface of said second frame and in communication with said sliding recess for guiding said rotating shaft to be introduced into said sliding recess, wherein as said rotating shaft is contacted with said top surface of said second frame, said rotating shaft is contacted with said guiding slant and further moved into said sliding recess along said guiding slant.

4. The scissors-type connecting member according to claim 3, wherein said first frame further comprises an auxiliary slant, wherein said auxiliary slant is formed on said axial surface of said rotating shaft, and disposed under said extension bulge to be contacted with said guiding slant, thereby assisting in introducing said rotating shaft into said sliding recess, wherein as said rotating shaft is contacted with said top surface of said second frame, said auxiliary slant is contacted with said guiding slant and moved along the guiding slant, so that said rotating shaft is introduced into said sliding recess.

5. The scissors-type connecting member according to claim 1, wherein a profile of said position-limiting cavity is identical to a profile of said extension bulge, and a size of said position-limiting cavity is larger than a size of said extension bulge.

6. The scissors-type connecting member according to claim 1, wherein said first frame is an inner frame, and said second frame is an outer frame, wherein said first frame is coupled to an inner side of said second frame.

7. A key structure with a scissors-type connecting member, said key structure comprising:
a base plate;
a keycap disposed over said base plate; and
said scissors-type connecting member arranged between said base plate and said keycap for connecting said base plate with said keycap, so that said keycap is movable upwardly or downwardly relative to said base plate, wherein said scissors-type connecting member comprises:
a first frame comprising a rotating shaft, wherein said rotating shaft is disposed on a first sidewall of said first frame, wherein said rotating shaft has an extension bulge, and said extension bulge is disposed on an axial surface of said rotating shaft; and
a second frame connected with said first frame and swingable relative to said first frame, and comprising a receiving recess, wherein said receiving recess is formed in a second sidewall of said second frame for accommodating said rotating shaft, wherein a position-limiting cavity is disposed within said receiving recess for accommodating said extension bulge, thereby limiting a rotating range of said extension bulge.

8. The key structure according to claim 7, wherein said second frame further comprises a sliding recess, wherein said sliding recess is formed in said second sidewall of said second frame and in communication with said receiving recess, wherein as said rotating shaft is contacted with said sliding recess, said rotating shaft is inserted into said sliding recess and further moved on said second sidewall of said second frame along said sliding recess, so that said rotating shaft is introduced into said receiving recess and accommodated within said receiving recess.

9. The key structure according to claim 8, wherein said second frame further comprises a guiding slant, wherein said guiding slant is formed on a top surface of said second frame and in communication with said sliding recess for guiding said rotating shaft to be introduced into said sliding recess, wherein as said rotating shaft is contacted with said top surface of said second frame, said rotating shaft is contacted with said guiding slant and further moved into said sliding recess along said guiding slant.

10. The key structure according to claim 9, wherein said first frame further comprises an auxiliary slant, wherein said auxiliary slant is formed on said axial surface of said rotating shaft, and disposed under said extension bulge to be contacted with said guiding slant, thereby assisting in introducing said rotating shaft into said sliding recess, wherein as said rotating shaft is contacted with said top surface of said second frame, said auxiliary slant is contacted with said guiding slant and moved along the guiding slant, so that said rotating shaft is introduced into said sliding recess.

11. The key structure according to claim 7, wherein a profile of said position-limiting cavity is identical to a profile of said extension bulge, and a size of said position-limiting cavity is larger than a size of said extension bulge.

12. The key structure according to claim 7, further comprising:
a membrane switch circuit disposed on said base plate, wherein when said membrane switch circuit is triggered, said membrane switch circuit generates a key signal; and
an elastic element disposed on said membrane switch circuit, wherein a lower portion of said elastic element is contacted with said membrane switch circuit, said elastic element is penetrated through said scissors-type connecting member, and an upper portion of said elastic element is contacted with said keycap, wherein when said elastic element is pushed by said keycap, said membrane switch circuit is triggered by said elastic element, wherein when a pressing force exerted on said keycap is eliminated, an elastic force provided by said elastic element is exerted on said keycap.

13. The key structure according to claim 7, wherein said first frame is an inner frame, and said second frame is an outer frame, wherein said first frame is coupled to an inner side of said second frame.
